(19) United States
(12) Patent Application Publication
(10) Pub. No.: US 2011/0059295 A1
(43) Pub. Date: Mar. 10, 2011

(54) Retroreflective pavement marking with improve performance in wet night conditions

(75) Inventors: Robert W. Greer, Lexington, NC (US); Simon Yakopson, Hickory, NC (US)

(73) Assignee: Flint Trading, Inc.

(21) Appl. No.: 12/584,512

(22) Filed: Sep. 8, 2009

(51) Int. Cl. B32B 3/30; B32B 5/16

(52) U.S. Cl. 428/149; 428/325

(57) ABSTRACT

A preformed thermoplastic pavement marking material with embedded large retroreflective beads resulting in a minimum retroreflectance of 100 mcd/m2/lx in standard conditions of wetness is described. The current composition includes these retroflective beads where more than 70% of the beads have diameters greater than 2 mm. The beads may be applied during manufacturing or installed by applying the retroreflective beads to a hot or un-cured matrix material composition.

### FIELD OF DISCLOSURE

The present disclosure relates to retroreflective pavement marking materials for traffic controls that exhibit good retroreflective brightness especially during wet driving conditions which include the following: night, dawn, dusk, or any form of darkness during the day.

### BACKGROUND OF DISCLOSURE

Pavement markings, such as those on the centerline and edgeline of a roadway, are important in order to provide visual guidance for motor vehicle drivers. Pavement marking materials are used as traffic control markings for a variety of uses, such as short distance lane striping, stop bars, and pedestrian pavement markings at intersections and long line lane markings, etc. on roadways. A common form of pavement marking material is adhesive-backed tape that is applied to the roadway surface in desired location and length which the top surface of the tape having selected color and typically retroreflective characteristics. The common denominator in all these materials and/or methods is that they are useful in areas where there is little or no wear.

Another common form of pavement marking material is thermoplastics used as preformed or direct (hot) applied materials. And yet another form of pavement marking are liquid applied marking, that can be solvent or water or latex based paints, curable polymer compositions based on epoxy, methylmethacrylate (MMA), polyurethanes and the like.

Glass beads used in traffic paints according AASHTO standards can be of Types 1, 2 and 3, shall have a minimum refractive index (nD; I.O.R.) of 1.5 and have average diameter of up to 1.5 mm. Usually these glass beads are made of common soda-lime glass and are inexpensive. Type 1 beads are used in the intermix for thermoplastic materials and in paints for retroreflection. Type 2 and 3 beads are embedded on surface of thermoplastic and curable materials for better retroreflective properties. Recently Type 5 beads were introduced in an attempt to improve retroreflectivity in wet conditions.

TABLE 1
Gradation of Glass Beads, Mass Percent Retained on a Sieve

| | U.S. | | | | |
|---|---|---|---|---|---|
| Diameter, | Sieve | | | | |
| microns | Size | Type I | Type II | Type III | Type V |
| 2350 | 8 | | | | 0% |
| 2000 | 10 | | | | 0-5% |
| 1700 | 12 | | | 0% | 5-25% |
| 1400 | 14 | | 0% | 0-5% | 60-90% |
| 1180 | 16 | 0% | | 5-25% | 95-100% |
| 1000 | 18 | | 0-5% | 60-90% | 98-100% |
| 850 | 20 | 0-10% | | 95-100% | |
| 710 | 25 | | 5-35% | 98-100% | |
| 600 | 30 | 10-25% | | | |
| 500 | 35 | | 55-90% | | |
| 300 | 50 | 65-85% | 90-100% | | |
| 150 | 100 | 95-100% | 95-100% | | |

Nevertheless, even if dry retroreflectivity of such flat materials can be very high, wet properties remain low and do not reach even minimal requirements for sufficient visibility (see below EN 1436 )

To enhance wet reflective properties of these materials, glass beads having high refractive indices of 1.9 to 2.2 - 2.3 or specially made high index elements (clusters) are added. However, these materials are significantly more expensive ( 5 to 20 times and more) compared with regular glass beads.

Currently, many flat, or low profile, pavement markings typically rely on an exposed-lens optical system having transparent microspheres partially embedded in a binder layer containing reflective pigment particles such as titanium dioxide or lead chromate. When the light from a vehicle's headlight enters the microsphere it is refracted to fall on the reflective pigment. A portion of the light is returned generally along the original entrance path toward the vehicle so as to be visible to the driver. The amount of refraction and the amount of light gathering of these microspheres is dependent in part upon maintaining a low index of refraction air interface on the exposed portion of the microsphere. During rainy periods, the microspheres become wet reducing their light refracting ability and resulting in much reduced retroreflective performance.

The present day low profile pavement markings provide effective retroreflective response for only a narrow range of entrance angles than is sometimes desired. For example, flat pavement markings, relying on microspheres partially embedded in layers containing diffuse pigments as described above, are most easily seen at distances of approximately 80 meters and less. This gives the driver approximately 3 seconds to respond while driving at 60 MPH. At speeds higher than this the time is reduced and in particular at distances greater than this, retroreflective brightness declines due in part to the relatively larger entrance angles of the incident light and in part to inherently limited retroreflective brightness. In addition to generally low retroreflectivity at high incidence angles, flat pavement markings are particularly difficult to see under rainy conditions for the reasons discussed above.

Another type of pavement marking known as “raised pavement markings” typically have better wet reflectivity because the rain will run off the raised portions and they sometimes use reflective systems that are inherently retroreflective when wet. Many of these are individual markings that have a height of one-half inch or more. However, snow removal is frequently a problem on roads bearing raised pavement markings, as the snowplows have a tendency to catch on the raised protrusions and dislodge the markings from the road surface. Also, raised pavement markings mounted as spot delineators provide relatively poor daytime-road delineation and thus commonly need to be augmented with continuous painted or tape line markings.

A problem with plastic pavement marker strips of the prior art is that of providing satisfactory adherence to the road surface under the constant use of motor vehicle traffic. The pavement marker must deform readily and flow without memory into the irregular surface contours of the pavement. The deformability and ability to cold flow permits the absorption of the energy of vehicle tire impacts that would otherwise violently dislodge the pavement marker as the impact energy is dissipated. Pavement markings applied with heat directly to the pavement surface have been shown to resist wear in heavy traffic areas such as stop bars, turn lanes and in-lane signage.

As described above there are environmental concerns related to traffic markings at night in wet conditions. Water impact and the subsequent reduction in retroreflective properties of microspheres, exposed lens optical systems that degrade when used in traffic wear areas and raised pavement markings that become dislodged during snow removal.

Wet reflective properties of traffic markings required to be visible in these conditions can be tested with the various ASTM methods such as ASTM 19806, ASTM 2176 and ASTM 2177. At this time there are no federal standards establishing requirements to wet reflective properties of pavement marking for roads with different average day traffic volume.

ASTM (WK) 19806 —Standard Test method for Measuring the Coefficient of Retroflective Luminence of Pavement Markings in a Standard and Representative Condition of Continuous Wetting. This is proposed testing method under consideration as alternative or addition to current standard ASTM E 2176 (below). The measurements are conducted under simulated rainfall of 1 ″ per hour and 2 ″ per hour.

ASTM E 2176: Standard Test Method for Measuring the coefficient of Retroreflected Luminance (RL) of Pavement Marking in a Standard Condition of Continuous Wetting—involves measuring wet retroreflectance under simulated 9 ″ per hour rainfall.

ASTM E 2177 —Standard Test Method for Measuring the Coefficient of Retroreflected Luminance (RL) of Pavement Markings in a Standard Condition of Wetness. According to this standard the test area of material is flooded with approximately 1 gal of water and then retroreflectivity is tested after 45 seconds.

While there are no American Federal Standard requirements to performance of road marking materials in wet conditions there is European standard specifying such requirements, which can be used as a reference for evaluating performance of proposed materials.

European standard EN 1436 (Road marking materials—Road marking performance for road users. Reflectance for dry road conditions; Reflectance for wet road conditions) provides condition for testing wet reflective properties and also requirements to performance depending on class of the road (amount of traffic and allowed speed).

According to EN 1436 wet reflective properties of road marking materials are tested somewhat similar to ASTM WK 19806 at 1 ″/h rainfall and to ASTM 2177. There are minimal differences in duration and rainfall of wetting before testing retreflectivity in conditions of continuous wetting (WK 19806 requires wetting for at least 1 min at 1 ″/h, EN 1436 requires wetting for 5 min at 20 mm/h; i.e. 0.8 ″/h) and continuous wetting ( 45 seconds after flooding for ASTM E 2177 and 1 min for EN 1436 )

Performance requirements for dry and wet road marking according to EN 1436 are exhibited in Table 2 below.

TABLE 2
Classes of R_{L} for dry road markings

| Road marking | | | Minimum coefficient of retroreflected |
|---|---|---|---|
| type and colour | | Class | luminance R_{L} mcd · m⁻² · lx⁻¹ |
| Permanent | White | R0 | No performance determined |
| | | R2¹⁾ | R_{L} ≧ 100 |
| | | R3¹⁾ | R_{L} ≧ 150 |
| | | R4¹⁾ | R_{L} ≧ 200 |
| | | R5¹⁾ | R_{L} ≧ 300 |
| | Yellow | R0 | No performance determined |
| | | R1¹⁾ | R_{L} ≧ 80 |
| | | R3¹⁾ | R_{L} ≧ 150 |
| | | R4¹⁾ | R_{L} ≧ 200 |
| Temporary | | R0 | No performance determined |
| | | R3¹⁾ | R_{L} ≧ 150 |
| | | R5¹⁾ | R_{L} ≧ 300 |

¹⁾in some countries these classes cannot be maintained during a limited time period of the year during which the probability of lower performance of the road markings is high, due to the presence of water, dust, mud etc.
The class R0 is intended for conditions, where visibility of the road marking is achieved without retroreflection under car headlamp illumination

TABLE 3
Classes of R_{L} for road markings during wetness

| | | Minimum coefficient |
|---|---|---|
| | | of retroreflected |
| Conditions of wetness | Class | luminance R_{L} mcd · m⁻² · lx⁻¹ |
| As obtained 1 min after flooding | RW0 | No performance determined |
| the surface in accordance with B.5 | RW1 | R_{L} ≧ 25 |
| | RW2 | R_{L} ≧ 35 |
| | RW3 | R_{L} ≧ 50 |
| | RW4 | R_{L} ≧ 75 |

Class RW0 is intended for cases where this type of retroreflection is not required for economic or technological reasons

TABLE 4
Classes of R_{L} for road markings during rain

| | | Minimum coefficient |
|---|---|---|
| | | of retroreflected |
| Conditions of rain | Class | luminance R_{L} mcd · m⁻² · lx⁻¹ |
| As obtained after at least 5 min | RR0 | No performance determined |
| exposure in accordance with B.6 | RR1 | R_{L} ≧ 25 |
| during uniform rainfall of 20 mm/h | RR2 | R_{L} ≧ 35 |
| | RR3 | R_{L} ≧ 50 |
| | RR4 | R_{L} ≧ 75 |

Class RR0 is intended for cases where this type of retroreflectivity is not required for economic or technological reasons.

Surprisingly, it has been found that beads made of regular glass with refractive index of 1.5 to 1.55 and with diameter higher than 2 mm ( 2.0 mm- 5.0 mm) and referred further as “Very Large Beads”, when used in traffic markings perform extremely well in wet conditions at night maintaining retroreflectivity similar to that of profiled pavement markings or pavement marking using high index beads or cluster elements. What is disclosed is a reflective pavement marking material with reflective glass bead sizes in a range of 2.0 mm to about 5 mm in diameter with excellent water runoff and sustained retroreflectivity.

### RELEVANT ART

U.S. Pat. No. 6,960,989, to Grayson, Thomas, and unassigned, describes a detectable warning method for providing a tactile warning upon a pavement surface, using a mold having a top surface and a plurality of dome creation cavities extending downwardly from the top surface. The dome creation cavities are spaced apart from each other in a grid, and having the steps of covering the top surface of the mold with a first sheet of thermoplastic material, coating the top surface and the mold and the dome creation cavities with a conforming continuous top layer of thermoplastic material by applying heat to the first sheet of thermoplastic material, creating a plurality of detectable warning domes by filling the dome creation cavities with a heat resistant material and creating a detectable warning carrier assembly by coating the detectable warning domes and top layer with a base layer of thermoplastic by fully covering the base layer and detectable warning domes with a second sheet of thermoplastic material and applying heat to the second sheet of thermoplastic material and applying the base layer to the pavement surface.

U.S. Pat. No. 7,142,095, to Grayson, Thomas, and unassigned, describes a detectable warning system for installation onto a pavement surface adjacent to a hazardous transition, having an attachment layer made up of one of a base layer and a top layer. The attachment layer is substantially planar and made of thermoplastic material, a plurality of domes made of a heat resistant material, the domes secured to the attachment layer and arranged in a grid thereupon, the carrier layer extending substantially planar between the domes, such that the attachment layer may be adhered to a pavement surface by applying heat thereto and the heat resistant material of the domes is unaffected by heat.

U.S. Pat. No. 5,087,148, to Wyckoff, Charles W., and assigned to Brite Line Corp., describes a roadway marker strip for adhesive attachment along a bottom surface of the strip to a roadway having a rubber-like sheet with a bottom layer and surface which possess cold-flow substantially memory-free characteristics and an upper layer and surface deformed into successive protuberances such as ridges and wedges from which incident light from a vehicle traveling along the roadway may be reflected or retro-reflected to indicate a roadway direction. The deformed upper layer and surface including the protuberances are cross-link-vulcanized so as to possess substantial memory enabling restoration of depression of the protuberances caused by vehicle.

U.S. Pat. No. 3,954,346, to Miller, George W., and unassigned, describes a safety strip and a combination length of a wear-resistant white rubber strip securable to a pavement or roadway by a rubber-based cement, a means for easily seeing the strip at night and particularly on rainy nights the strip has a cross-sectionally upwardly rounded upper surface. The means has a series of multi-faceted, diamond-shaped glass reflectors protruding upwardly from the upper surface of the strip, with the reflectors being anchored in the strip by lengths of rods and each reflector incorporating a downward extending stem, each stem having a transverse opening therethrough receiving the rod, and the rods extending along a longitudinal direction of the strip.

U.S. Pat. No. 3,392,639, to Heenan, et. al., and assigned to Elastic Stop Nut Corp.of America, describes a pavement marker for providing a marking on a generally horizontal roadway surface, the marking being visible from an oncoming vehicle on the roadway both during the day and during the night, said pavement marker having a body of synthetic resin having at least one portion providing a face located in a position to be viewed from the oncoming vehicle, the body portion having a first part which is opaque, the first part providing a first facial portion capable of being effectively viewed in daylight and a second part which is light transmitting and has an outer, obverse light receiving and refracting surface, and inner, reverse light receiving and reflecting surface and a retro-directive reflecting system in the reverse surface for receiving light from emanating from the oncoming vehicle and incident upon the obverse face and reflecting such light generally parallel to the angle of incidence for rendering the second part reflective and providing a second facial portion capable of being effectively viewed at night. Each of the first and second facial portions are oriented as to make an acute angle with the horizontal and to rise above the roadway surface upon which the pavement marker is to be installed, each acute angle is great enough to reduce deterioration of the first and second facial portions arising out of contact with the oncoming vehicle while being small enough to allow adequate wiping of the first and second facial portions by such contact with the acute angle of the first facial portion being great enough to provide a sufficiently large projected viewable area and the acute angle of the second facial portion being great enough to maintain adequate optical effectiveness of the retro-directive reflective system during service.

U.S. Pat. No. 6,247,872, to Mercato, Forrest C., and assigned to The Rainline Corp., describes an apparatus for applying a traffic stripe to a road surface having at least one vehicle, a first applicator operatively attached to the vehicle for applying a traffic stripe material to the road surface, the applicator including a first member securable in a first position for allowing the material to be road surface and in a second position for preventing the material from exiting the applicator. There is a second member capable of being adjustably positioned such that it forms the stripe with at least one portion having a first height and at least one portion having a second height, the second height being greater than the first height, a second applicator for applying a reflective material to the traffic stripe and a deformation member spaced from the first applicator and a lifting mechanism that raises the deformation member at predetermined intervals such that the deformation member forms a profile in at least one portion of the stripe having a first height and in at least one portion of the stripe having a second height such that the second height remains greater than the first height.

U.S. Pat. No. 6,479,132, to Hedblom, et. al., and assigned to 3 M, describes a pavement marking article having a monolayer of exposed-lens optical elements, a reflective layer, and a spacing layer between the optical elements and the reflective layer. The average thickness of the spacing layer relative to the average radius of the optical elements is selected such that when wet the article has a coefficient of retroreflection, RA, greater than 3.1 Cd/LX/M 2.

U.S. Pat. No. 6,365,262, to Hedblom, et. al., and assigned to 3 M, describes a pavement marking article having a monolayer of optical elements with an exposed-lens surface portion and an embedded-lens surface portion, a spacing layer in which the optical elements are partially embedded with the average thickness of the spacing layer relative to the average radius of the optical elements. The article has greater wet retroreflectivity than an article made without the spacing layer, a coefficient of retroreflective luminance, RL, of at least about 150 mCd/m 2 / Lx during rainfall and a reflective layer next to the spacing layer.

U.S. Pat. No. 5,777,791, to Hedblom, et. al., and assigned to 3 M, describes a retroreflective pavement marker having a base sheet having a front surface and a back surface and a plurality of protrusions projecting from the front surface of the base sheet. Each of the protrusions has a top surface and at least one side surface connecting the top surface to the front surface of the base sheet. Additionally a binder layer having particles of specular reflector pigment covering a portion of the protrusions and partially embedded in the binder layer, of a plurality of Type A microspheres and a plurality of Type B microspheres, wherein at least 10 percent by weight of the total microspheres are Type A and at least 10 percent by weight of the total microspheres are Type B. The Type A microspheres have a different average refractive index than do the Type B microspheres and the Type B microspheres have an average refractive index of about 2.2 to about 2.3.

U.S. Pat. No. 6,703,108, to Bacon, et. al., and assigned to 3 M, describes a retroreflective material having on a top surface thereof an enclosed-lens retroreflective sheet that comprises a cover layer, a monolayer of retroreflective elements and a specular reflector or an air interface protected by a sealing film. A first portion of the monolayer is arranged in an upwardly contoured profile and second portion of the monolayer arc arranged in a lower, substantially planar horizontal position. The material has a plurality of the first portions and a plurality of the second portions and wherein the material exhibits bright retroreflective performance under both wet and dry conditions such that the minimum retroreflective brightness of the material is at least 50 percent of the maximum retroreflective brightness of such material at any orientation angle at a constant entrance angle.

U.S. Pat. No. 6,841,223, to Rice, et. al., and assigned to 3 M, describes a composite pavement marking having a marking length and a marking width transverse to the marking length. The marking width is defined by marking sides extending along the marking length, wherein the pavement marking further includes a bottom extending along the marking length and marking width, the pavement marking having a first portion width between first portion sides that is less than the marking width, a unitary retroreflective article attached to the first portion of the pavement marking, wherein a first portion height is defined by the distance between a top surface of the unitary retroreflective article and the bottom of the pavement marking, and wherein the unitary retroreflective article has a width that is substantially equal to the first portion width; and a second portion surrounding the first portion on at least two opposing sides, wherein the second portion comprises a second portion height above the bottom of the pavement marking that is different than the first portion height.

Chinese Publication No. CN 1099832 A, to Bollag, Moses, and assigned to Plastiroute, S. A., describes a reflecting body made of transparent material has coated paint speckles so provided on its surface that the light ray can enter the reflecting body and its intensity is sufficient to produce a reversal reflection and thus a light ray is ejected from the reflecting body. For the sake of controlling traffic in nighttime and moist day, it is placed on the laid pavement of a road or on the traffic borne road surface or on the plane marking line or on the traffic control road surface.

European Publication No. EP 0385746 B 1, to Kobayashi, et. al., and assigned to Atom Chemical Paint Co. Ltd., describes a high-brightness all-weather type pavement marking sheet material having a reflex-reflecting sheet with a layer of glass microspheres of a relatively large diameter which are at least partially exposed in air and bonded to one another by a transparent resin. The reflecting layer consisting of a metallized film provided behind the transparent resin layer and a base sheet bonded to the lower surface of the reflex-reflecting sheet, characterized in that a layer of glass microspheres of a relatively small diameter are buried and fixed in a transparent resin layer between the layer of glass microspheres of a relatively large diameter and the reflecting layer, there being an interval between the glass microspheres of a large diameter and the glass microspheres of a small diameter and in that the base sheet is made of rubber of synthetic resin.

European Publication No. EP 0237315 A 3, to Ishihara, et. al., and assigned to SEIBU POLYMER KASEI KABUSHIKI KAISHA, describes an all-weather type pavement marking sheet material having a base sheet made of rubber, synthetic resin or the like and glass microspheres having refractive index of 1.5 - 1.9 and glass microspheres having refractive index of 2.0 - 2.4 embedded mixedly and at least partially in a portion of the base sheet. The portion is formed at intervals in the longitudinal direction of the base sheet or continuously in the longitudinal direction of the base sheet in a part of the base sheet as viewed in the transverse direction of the base sheet.

Japanese Publication No. JP 09228328 A 2, to Nakajima, et. al., and assigned to Sekisui Jushi Co. Ltd., describes a light reflective fine particle and a flowing resin that are injected to a die having a dent in the lower part, and the light reflective fine particle is settled in the flowing resin, or the flowing resin is injected after the light reflective fine particle is filled in the dent followed by hardening creating a road surface marker in which the light reflective fine particle is collected to the surface. A protruding part Y is manufactured by integral molding of a synthetic resin. After the resin is hardened, when a flowing resin layer of the same kind containing a fiber is superposed followed by hardening, a reinforcing layer can be formed on the reverse side. The marker has the protruding part Y on a lengthy tape X having a thickness T of 0.5 -10 mm and a width of 50 - 500 mm, and the protruding part Y has a height D of 3 - 10 mm and a length L of 20 - 300 mm. Thus, the protruding part Y is protruded from the rainwater surface even in a rainy night, and a sufficient reflectivity can be ensured.

Canadian Publication No. CA 2033527 C, to Dinitz, Arthur, and unassigned, describes a safety roadway delineator including one or more elongate recessed marker surfaces which are coated with a reflective material, preferably a retroreflective material such as reflective glass beads. The recessed marker surfaces are vertical or at least inclined to the horizontal to insure water run-off and are formed either directly in cast-in-place concrete roadway members or in pre-cast polymer concrete facing panels that are attached to the cast-in-place concrete roadway members. The roadway delineator is substantially continuously protected from normal wear and reliably exhibits reflectivity both under dry and rainy weather conditions.

### SUMMARY OF THE DISCLOSURE

Disclosed is a pavement marking material and product with improved visibility in wet night conditions having a base layer material that provides adhesion to a pavement surface and which is embedded with relatively large retroreflective glass beads that are within a range of diameter of 2 mm to about 5 mm.

In another embodiment the base layer material is paint, latex, or curable polymer coatings; such as methylmethacrylate (MMA), polyurethane, epoxy, polystyrene, acrylics and other applicable materials, as well as thermoplastic materials, hot applied and preformed.

In another embodiment the preformed thermoplastic pavement marking material may be adhered to the pavement with or without pre-heating of the pavement.

### BRIEF DESCRIPTION OF THE DRAWINGS

FIG. 1A is a section view of a preformed thermoplastic pavement marking with various sized retroreflective beads.

FIG. 1B is a top view of a preformed thermoplastic pavement marking with various sized retroreflective beads.

### DETAILED DESCRIPTION OF THE DRAWINGS

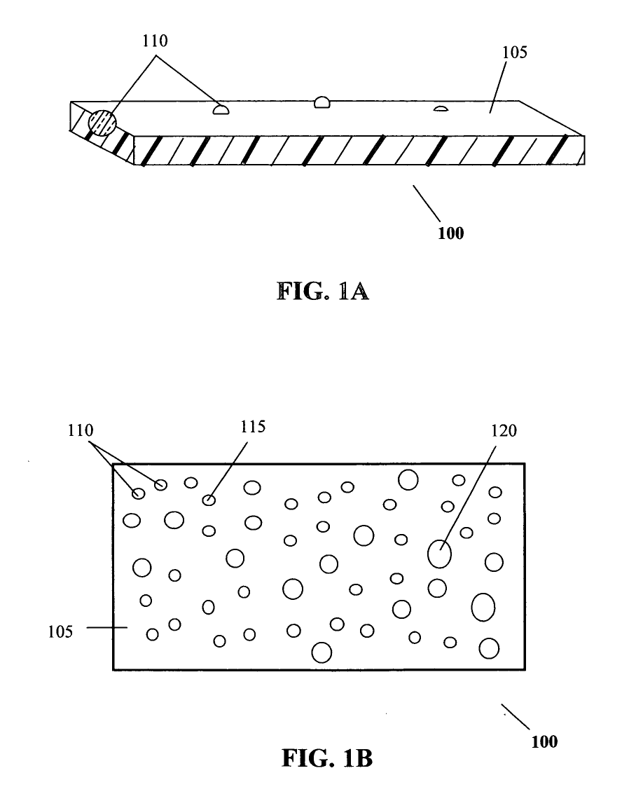

FIG. 1 is a section view of a preformed thermoplastic pavement marking [100] with various sized retroreflective beads [110] embedded in the thermoplastic pavement marking material [105].

FIG. 1B is a top view showing the thermoplastic pavement marking [105] material that contains reflective and/or retroflective beads [110] that are from 2.0 mm diameter [115] to about 5 mm diameter [120] that shed water from the exposed curvatures thereby maintaining the retroreflectivity in rainy and/or wet environments and also maintaining consistent reflectivity as the angle and intensity of the light from the vehicle headlights changes due to changes in the distance from the reflective element. The terms reflective and/or retroflective beads and reflective and/or retroflective elements are used interchangeably.

When adherence of a preformed thermoplastic pavement marking (PTPM) material to a roadway surface is performed, the PTPM material may be heated to a desired temperature and softened to provide and allow for embedding of drop-on reflective/retroflective elements.

The application of the PTPM to a surface is performed by heating to a desired temperature causing the base layer to melt onto and into the pavement surface. Optionally, the pavement surface may be preheated prior to application of the PTPM.

In an additional embodiment the retroreflective beads may be within the range of 4-10 mesh (ASTM) with the largest of portion beads used being in the range of 6-8 mesh.

In another embodiment the drop-on (surface applied) beads may be applied during production or during installation to the selected pavement

In another embodiment the retroreflective beads and/or the pavement marking material may be preheated before dropping the retroreflective beads onto the pavement marking material.

In another embodiment the retroreflective beads and/or the base layer may be preheated such that the temperature of the beads to the base layer is in a desired ratio such that the beads are completely embedded into the base layer, thus creating retroreflective beads deeply intermixed allowing increased long term performance.

In another embodiment the drop-on (surface applied) elements may be friction-enhancing materials such as cullet, crushed glass, corundum, sand or other stone material.

In another embodiment the cullet crushed glass, corundum, sand or other stone material, is a certain ASTM mesh and combined with retroreflective beads in a 1:3 to 3:1 ratio.

In another embodiment the retroreflective beads and the base layer may be melted together to form a monolithic material with a preformed thermoplastic material (PTPM), which allows for ease of application by using a flame torch to apply the PTPM directly to the pavement in a single step.

In another embodiment the large retroreflective beads exhibit a higher retroreflective luminescence than with a flat marking with standard sizes beads, thereby providing for better reflectivity and visibility in wet/rainy and/or nighttime conditions.

Very large reflective glass beads with relatively low “standard” refractive index produce wet retroflective luminescence (RL) comparable, after aging, to that of high index clusters or profiled materials with high index beads, however the very large glass beads are a significantly lower cost to produce and utilize a simpler application process.

TABLE 5
Comparative cost of the reflective materials used in
retroreflective pavement marking materials

| Reflective material | Cost, $$ per lb. |
|---|---|
| 1.5 IOR* Very Large Beads | 0.40-0.60 |
| 1.5 IOR Glass beads type 1 | 0.30-0.50 |
| 1.5 IOR Glass beads type 3 | 0.40-0.60 |
| 1.5 IOR Glass beads Type 5 | 0.40-0.60 |
| 1.9 IOR High Index Beads | 2.30-3.50 |
| 1.9 IOR High Index Clusters | 5.00-8.00 |
| 2.2 IOR High Index Clusters | 6.00-10.00 |

*IOR—index of refraction

An important distinction found in the course of developing the present invention, is that while the cost of Very Large Beads is comparable with the cost of other regular glass beads, its performance is surprisingly similar to that of the high index grade materials.

Table 6 compares gradation of beads and indicates the difference in performance between glass beads of various sizes as measured by ASTM E-11-81 sieve number.

TABLE 6
Comparative Distribution of Reflective Beads by Sizes (Actual Data)

| | | Retained on Sieve, | | |
|---|---|---|---|---|
| | | % of total weight | | |
| | | Specification | | |
| ASTM E-11-81 | Opening Size | for Proposed | | |
| Sieve Number | Mm | Very Large | Type 5 | Type 3 |
| 4 | 4.75 | 1% | | |
| 5 | 4 | 2% | | |
| 6 | 3.36 | 8.0% | | |
| 7 | 2.8 | 26.0% | | |
| 8 | 2.4 | 35.0% | 0% | |
| 10 | 2 | 27.1% | 2% | |
| 12 | 1.7 | 0.7% | 16% | 0% |
| 14 | 1.4 | | 76% | 6% |
| 16 | 1.18 | | 4% | 13% |
| 18 | 1 | | 2% | 75% |
| 20 | 0.85 | | | 5% |
| 25 | 0.71 | | | 1% |

Comparison of preformed thermoplastics with different drop-on reflective materials is shown in Table 7. All data shown is for the material compositions applied on the road in wheel tracks with moderate ADT (average day traffic) 10 weeks after installation was completed.

TABLE 7
Comparison of Retroreflectivity (R_{L,} mcd/m2/lx) of
Proposed Material vs. Current Materials, Moderate Average Daily Traffic

| | | ASTM | | | ASTM |
|---|---|---|---|---|---|
| | | WK 19806 | | ASTM | E-2176 |
| | Spot | pre-standard | | E-2177 | R_{L} after |
| Surface Applied | Dry | R_{L} at | R_{L} at | R_{L} at | recovery |
| Beads/Clusters | R_{L} | 1″/h | 2″/h | 9″/h | for 45 s |
| Proposed material with very | 283 | 110 | 75 | 36 | 113 |
| large glass beads (n_{D} 1.5) | | | | | |
| (Example 1) | | | | | |

Flat Materials with Regular Glass Beads (1.5 IOR)

| | | | | | |
|---|---|---|---|---|---|
| Flat preformed thermoplastic | 454 | 41 | 36 | 18 | 48 |
| made with T5 beads | | | | | |
| Flat preformed thermoplastic | 385 | 36 | 39 | 13 | 26 |
| made with T3 beads | | | | | |
| Hot applied thermoplastic | 330 | 37 | 28 | 10 | 33 |
| made with T1 beads | | | | | |
| Latex paint made with T1 | 246 | 29 | 22 | 8 | 23 |
| beads | | | | | |

Flat and Profiled Materials
with High Index Beads and Cluster elements
High Index Beads Clusters

| | | | | | |
|---|---|---|---|---|---|
| 1.9 IOR clusters with polymer | 330 | 58 | 42 | 10 | 38 |
| binder | | | | | |
| 1.9 IOR beads coated over | 348 | 45 | 45 | 25 | 78 |
| larger glass bead core | | | | | |
| 1.9 IOR clusters with ceramic | 559 | 59 | 54 | 31 | 98 |
| binder | | | | | |
| 2.2 IOR beads clusters with | 484 | 49 | 61 | 48 | 192 |
| ceramic binder | | | | | |

Profiled Material

| | | | | | |
|---|---|---|---|---|---|
| Profiled tape made with | 227 | 78 | 77 | 28 | 129 |
| 2.2 IOR beads | | | | | |

The base layer for the PTPM is at least 1.5-5 mm thick, preferably 3.0 to 4.0 mm thick.

Hydrocarbon and alkyd based resin can be used for base thermoplastic materials. The materials composition contains at least 18% binder together with glass beads, pigments, fillers and rheology modifiers. Binders can include polymers, tackifiers, plasticizers and/or waxes.

Curable polymer compositions can include epoxy resins, methyl methacrylate compositions paints, and latexes capable of creating dry films with thicknesses exceeding 50 mil.

The following are examples of certain compositions suitable for the purpose of this invention. All data shown below is for the material compositions applied on the road in wheel tracks with corresponding average day traffic as noted (moderate or high ADT) after 10 weeks in direct traffic exposure.

### EXAMPLE I

An example of the hydrocarbon resin composition for base layer of preformed thermoplastic is provided as:

Material composition

| | |
|---|---|
| Escorez 1315 | 10% |
| C5 hydrocarbon resin | 5% |
| Refined mineral oil | 2% |
| Escorene EVA MV 02514 | 3% |
| Fumed silica | 0.5% |
| Titanium dioxide (Rutile) | 10% |
| Glass beads Type 1 | 20% |
| Sand | 19.5% |
| CaCO3 | 30% |

The material composition has a softening temperature (R&B) of 116° C. measured according to ASTM D36-06, Standard Test Method for Softening Point of Bitumen (Ring-and-Ball Apparatus)

The material composition was extruded using a casting die to create 125 mil thick preformed thermoplastic sheets, and during extrusion very large beads were dropped on the melted material immediately after coming out of the die. Subsequently at a location further from the die exit on the manufacturing line, additional corundum was added to the material and indented visual heating indicators were applied to the surface.

The material composition was installed on asphalt pavement on the road surface with moderate ADT traffic. After 10 weeks it exhibited the properties shown in Table 8.

TABLE 8
Moderate Average Daily Traffic

| | | ASTM | | | ASTM |
|---|---|---|---|---|---|
| | | WK 19806 | | ASTM | E 2176 |
| | Spot | pre-standard | | E-2177 | R_{L} after |
| | Dry | R_{L} at | R_{L} at | R_{L} at | recovery |
| Surface Applied Material | R_{L} | 1″/h | 2″/h | 9″/h | for 45 s |
| Proposed material with very | 283 | 110 | 75 | 36 | 113 |
| large beads (n_{D} 1.5) | | | | | |

### EXAMPLE II

In another example, in this case including base material that is an alkyd resin composition is provided:

Example of alkyd resin composition

| | |
|---|---|
| Polyamide resin Unirez 2633 | 7% |
| Modified rosin resin Sylvacote 4981 | 7% |
| Phthalate plasticizer | 3% |
| PE based wax | 2.0% |
| Fumed silica | 0.3% |
| Glass beads T1 | 30% |
| Glass beads T3 | 10% |
| TiO2 | 10% |
| CaCO3 | 30.7% |

This material composition softening temperature (R&B) is 127° C.

This material composition was extruded in the same manner as Example 1 and installed in an area with high ADT traffic. After 10 weeks it exhibited the properties shown in Table 9.

TABLE 9
High Average Daily Traffic

| | | ASTM | | | ASTM |
|---|---|---|---|---|---|
| | | WK 19806 | | ASTM | E 2176 |
| | | pre-standard | | E-2177 | R_{L} after |
| | Spot | R_{L} | R_{L} at | R_{L} at | recovery |
| Surface Applied Material | Dry R_{L} | at 1″/h | 2″/h | 9″/h | for 45 s |
| Proposed material with | 385 | 87 | 65 | 27 | 185 |
| very large beads | | | | | |
| (n_{D} 1.5); Example 2 | | | | | |

### EXAMPLE III

This material composition includes an alkyd type base layer for use in hot applied formulations:

| | |
|---|---|
| Modified rosin resin Sylvacote 4981 | 8% |
| Modified rosin resin Sylvacoat 7021 | 9% |
| Castor oil based plasticizer | 3% |
| PE based wax | 2.0% |
| Glass beads T1 | 30% |
| TiO₂ | 10% |
| CaCO₂ | 38% |

This material composition softening temperature (R&B) was 118° C.

Very large beads were dropped on this material composition in the hot state as it was applied to the pavement. Performance of this material composition after 10 weeks of traffic exposure is provided in Table 10.

TABLE 10
High Average Daily Traffic

| | | ASTM | | | ASTM |
|---|---|---|---|---|---|
| | | WK 19806 | | ASTM | E 2176 |
| | | pre-standard | | E-2177 | R_{L} after |
| | Spot | R_{L} | R_{L} at | R_{L} at | recovery |
| Surface Applied Material | Dry R_{L} | at 1″/h | 2″/h | 9″/h | for 45 s |
| Proposed material with | 420 | 93 | 77 | 29 | 146 |
| very large beads | | | | | |
| (n_{D} 1.5); Example 3 | | | | | |

### EXAMPLE IV

In this case a paint type base layer was used for the material composition, which was formulated on UCAR latex DT 400 (Dow Chemical Corp.), the constituency of which is described below:

| | |
|---|---|
| UCAR Latex DT 400 | 52.23% |
| DOWICIL 75. | 0.04% |
| Drewplus L-493 | 0.27% |
| Colloid 226/35 | 0.71% |
| Propylene Glycol | 2.28% |
| Natrosol 250 HBR | 0.03% |
| Water | 3.56% |
| Ti-Pure R-900 | 2.96% |
| Omyacarb 5 | 34.90% |
| Texanol | 2.63% |
| Drewplus L-493 | 0.40% |

Latex paint was prepared based on UCAR Latex DT 400 (Dow Chemical Corp.) according to the manufacturer's instructions. First, a layer of paint was applied to the pavement and let dry slightly for 5 min. Next a second layer was applied to accomplish a 50-60 mil thickness film of paint. Immediately after application of the second layer of paint, very large beads were dropped on and embedded into the paint. After the paint was dried, the beads were embedded into this material composition. Performance of this material composition after 10 weeks in traffic is shown in Table 11.

TABLE 11
Moderate Average Daily Traffic

| | | ASTM | | | ASTM |
|---|---|---|---|---|---|
| | | WK 19806 | | ASTM | E 2176 |
| | | pre-standard | | E-2177 | R_{L} after |
| | Spot | R_{L} | R_{L} at | R_{L} at | recovery |
| Surface Applied Material | Dry R_{L} | at 1″/h | 2″/h | 9″/h | for 45 s |
| Proposed material with | 320 | 87 | 69 | 26 | 129 |
| very large beads | | | | | |
| (n_{D} 1.5); Example 3 | | | | | |

### EXAMPLE V

For this example, methylmethacrylate (MMA) Extrude “100% solid” two-component paint type 25W-G012 (Aexel Corp.) was utilized as the base layer.

Initially, the 25W-G012 MMA was sprayed as the base component, followed by application of a catalyst, followed by subsequent curing for 4-6 min. Next the application of a second layer to partly cure the base material was accomplished in order to build up sufficient thickness of the film. Immediately thereafter, very large beads were dropped into the partially cured film that was subsequently allowed to completely cure for 15-20 min.

Performance of this material composition after 10 weeks in traffic is shown in Table 12.

TABLE 12
Moderate Average Daily Traffic

| | | ASTM | | | ASTM |
|---|---|---|---|---|---|
| | | WK 19806 | | ASTM | E 2176 |
| | | pre-standard | | E-2177 | R_{L} after |
| | Spot | R_{L} | R_{L} at | R_{L} at | recovery |
| Surface Applied Material | Dry R_{L} | at 1″/h | 2″/h | 9″/h | for 45 s |
| Proposed material with | 341 | 91 | 72 | 31 | 156 |
| very large beads | | | | | |
| (n_{D} 1.5); Example 3 | | | | | |

### EXAMPLE VI

A Polyester Traffic marking Paint Lane-Line® two component type 75W-D012 (Aexel Corp) application was provided as follows; The 75W-D012 two component system was initially sprayed providing a base component, followed by addition of a peroxide catalyst, and then allowed to cure for 5-7 min. Next, a second layer was applied and allowed to partially cure—again to provide sufficient film thickness. Immediately thereafter, very large beads were dropped into the film which the entire composition was allowed to reach a complete cure within 25-30 min.

Performance of this material composition after 10 weeks in traffic is shown in Table 12.

TABLE 12
Moderate Average Daily Traffic

| | | ASTM | | | ASTM |
|---|---|---|---|---|---|
| | | WK 19806 | | ASTM | E 2176 |
| | | pre-standard | | E-2177 | R_{L} after |
| | Spot | R_{L} | R_{L} at | R_{L} at | recovery |
| Surface Applied Material | Dry R_{L} | at 1″/h | 2″/h | 9″/h | for 45 s |
| Proposed material with | 299 | 88 | 66 | 27 | 134 |
| very large beads | | | | | |
| (n_{D} 1.5); Example 3 | | | | | |

It should be understood that although the examples given provide specific formulations and compositions of the present application, it should be understood that these examples include the basic inventive concepts but that many additional variations of the present invention are also possible while still adhering to the inventive concept disclosed herein.

What is claimed is:

1. A retroreflective pavement marking material composition comprising:
a base layer composition for application to a pavement substrate
and a top layer comprising retroflective glass beads wherein said beads range in size from greater than 2 mm to about 5 mm, wherein said base layer and said top layer combine to form a single composite film.

2. The retroreflective pavement marking material composition of claim 1, wherein said material is a preformed thermoplastic comprising a base layer composition for application to a pavement substrate by heating said base layer to a predetermined temperature such that said retroreflective pavement marking material permanently adheres to said pavement substrate.

3. The retroreflective pavement marking material composition of claim 2, wherein said base layer composition is an alkyd based resin.

4. The retroreflective pavement marking material composition of claim 2, wherein said base layer composition is a hydrocarbon based resin.

5. The retroreflective pavement marking material composition of claim 1, wherein said retroreflective glass beads are combined with sand, corundum, crushed glass or other stone material to provide various forms of surface texturing.

6. The retroreflective pavement marking material composition of claim 1, wherein said retroreflective beads are properly disposed on the surface of said material composition thereby providing a retroreflective pavement marking material, and wherein said retroreflective beads combine to form with one or more retroreflective pavement marking material compositions to allow for functioning as a retroreflective pavement marking material wherein said retroreflective beads penetrate a depth of between 20 and 80 percent of a total film thickness of said retroreflective pavement marking material composition.

7. The retroreflective pavement marking material composition of claim 1, wherein said retroreflective beads exhibit a retroreflectance luminescence value of at least 100 mcd/m²/lx under standard condition of wetness and wherein said retroreflective beads exhibiting said retroreflective luminescence value provides improved wet/rainy and/or nighttime reflectivity and visibility.

8. The preformed retroreflective pavement marking material composition of claim 3, wherein said alkyd resin-based composition comprises; approximately 20 weight percent binder, said binder comprising alkyd resins and malefic modified resin together with plasticizer, vegetable oils, phthalate esters, mineral oil, castor oil, wax and other suitable flexibilizers, paraffin wax, polyamide and ethylene vinyl acetate or styrene-butadiene-styrene terpolymers, approximately 2-10 weight percent pigments including; titanium dioxide, lead chromate, and organic dyes, approximately 30-40 weight percent metal carbonate fillers, and up to approximately 30-40 weight percent retroreflective beads.

9. The retroreflective pavement marking material composition of claim 1, wherein said retroreflective beads are embedded into said base layer composition during manufacture of said base layer.

10. The retroreflective pavement marking material composition of claim 1, wherein said retroreflective beads are embedded at the installation site into said base layer composition as heating of said base layer occurs.

11. The retroreflective pavement marking material composition of claim 1, wherein said base layer-comprises paint, latex, and curable polymer coatings including methylmethacrylate (MMA), polyurethane, epoxy, polyester, and acrylics as well as other suitable polymers.

12. The retroreflective pavement marking material composition of claim 1, wherein said retroreflective beads are with a range of from 4 to 10 mesh as defined by ASTM, and more preferably in the range of between 6 and 8 mesh.

13. The retroreflective pavement marking material composition of claim 2, wherein said retroreflective beads and said base layer are preheated such that the ratio of the temperature of said retroreflective beads to the temperature of said base layer provides for said retroreflective beads to completely embed and homogeneously intermix with said base layer, thereby creating a thermoplastic warning device which exhibits increased long term performance.

14. The thermoplastic retroreflective pavement marking material composition of claim 13, wherein said retroreflective beads and said base layer are melted together to form a monolithic material composition such as a film together with a preformed thermoplastic material (PTPM), wherein said monolithic material composition provides for direct single step application to said pavement substrate by use of a flame torch.
